(19) United States
(12) Patent Application Publication
(10) Pub. No.: US 2009/0106197 A1
(43) Pub. Date: Apr. 23, 2009

(54) System and method for creating a collection of business listings

(76) Inventors: S. Charles Bennett, III, Naples, FL (US); Kenneth M. Marwick, Bonita Springs, FL (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/974,956

(22) Filed: Oct. 17, 2007

(51) Int. Cl. G06F 17/30

(52) U.S. Cl. 707/3; 707/E17.108

(57) ABSTRACT

A system and method for developing a local business listing Internet site through member generated business listings is described. The members of the service provider providing the site are compensated with a portion of the money received by the service provider for the member created listings.

### PRIORITY CLAIM

The present invention is related to, and claims the benefit of U.S. Provisional Application No. 60/852,186, filed on Oct. 16, 2006.

### FIELD OF INVENTION

Embodiments of the present invention relate to a system and method of collecting of information, not available on the Internet, as well as the authorship, posting, editing, and management of said information.

### BACKGROUND

There are scores of information gathering protocols that have been utilized through the years. These protocols however, have neglected to compile comprehensive and current information on the vast majority of businesses for the purpose of making the information easily accessible to the general public. Small businesses comprise 90% of all US companies. These small businesses drive the nation's economy, offering 75% of new jobs and generating 50% of America's private sector output. There are 22.9 million small businesses and the number continues to grow at a rapid pace.

In the 21st century, the Internet has become the primary source of information for consumers. However, the Internet can only provide information that is already stored and properly managed within the existing Internet domain. Algorithms and other mathematical equations, the nervous system that locates the data within the Internet, are of no use if the information desired has yet to be collected. Though, a significant number of businesses, including small businesses, are listed by categories, with a name, address and phone number, no comprehensive or current description of these businesses, their products, or services, or in the case of professionals, their biographical history, is as yet available.

Consumers need information and today, most of the information on businesses, products and services, are compiled on the larger businesses that market their products on a national or international scale. But consumers also require comprehensive and comparative information on the products and services available in their local markets. They want current information on what doctor, lawyer, or real estate agent to use; which store sells a specific product, or which stores are having sales and specials; where the best deals are on cars, insurance, dining; etc. Consumers spend the vast majority of their expendable dollars on small businesses, usually local businesses. It is estimated that consumers spend as much as 90% of their disposable income on local products and services and most of these products and services stem from small businesses. Consumers require information beyond a simple, name, address and location. They want current and more comprehensive information so they can make an informed decision before they spend money.

The typical methods of collecting new and accurate information, including information on a significant number of businesses and professionals are inherently ineffective. This is the primary reason that the information has yet to be compiled and properly managed. First, since the vast majority of businesses are small businesses, the owners or managers, generally lack either the time, knowledge, initiative or the financial capability to initiate and manage an online presence relating to their business. It is estimated that over 50% and as many as 95% of businesses, as yet, have any level of comprehensive information on their business, online. Secondly, the typical methods of collecting a mass of information, via surveys, whether telephone, face to face, or even online, are not effective for a number of reasons, (1) the cost to pay enough individuals to collect and compile such a massive amount of information has been prohibitive for most private enterprises and (2) the intrusiveness of one taking the survey limits both the ability to reach the necessary individual authorized to provide the information, as well as the inclination of the individual not to provide information to a stranger.

Therefore, the inefficiencies of a conventional survey are reasonably ineffective. Another reason that businesses or professionals are hesitant to provide information is because of their inability to easily edit, revise or correct the information, as necessary, therefore creating a major concern, on their part, that must be addressed.

Accordingly, there is a need for a methodology to collect information on literally millions of businesses and professionals, compiling the information in a centralized data system and making that information, manageable and updatable for current accuracy, as well as easily available to the general public.

### BRIEF DESCRIPTION OF THE DRAWINGS

The present invention is illustrated by way of example and not limitation in the figures of the accompanying drawings, in which like references indicate similar elements and in which:

FIG. 1 illustrates an embodiment of the overall system for providing member created business listings;

FIG. 2 illustrates an embodiment of a listing search page;

FIG. 3 illustrates another embodiment of a listing search page;

FIG. 4 illustrates an exemplary result of a listing search;

FIG. 5 illustrates an exemplary business listing;

FIG. 6 illustrates an exemplary professional listing;

FIG. 7 illustrates an embodiment of a method for registering a member with the service provider;

FIG. 8 illustrates an embodiment of a member dashboard;

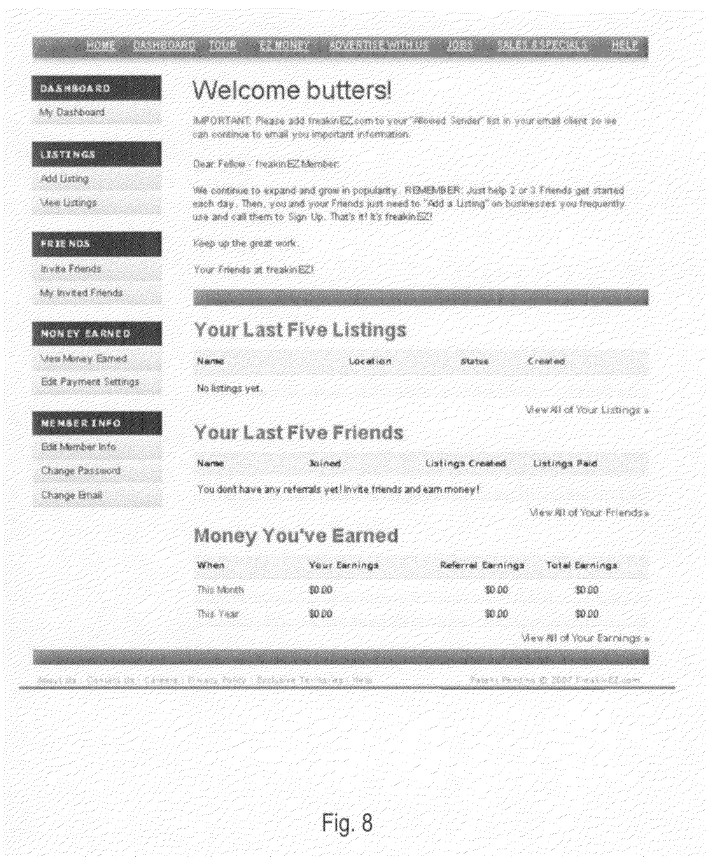

FIG. 9 illustrates an embodiment of a method for referring (inviting) a friend to the service provider;

FIG. 10 illustrates an embodiment of a method for developing a listing by a member;

FIG. 11 illustrates an exemplary first “add listing” page that is accessible from a dashboard;

FIG. 12 illustrates an exemplary page on which the member selects an existing business listing or if the business does not have a listing;

FIG. 13 illustrates an exemplary second “add listing” page;

FIG. 14 illustrates an embodiment of a method for a business to sign-up with the service provider;

FIG. 15 illustrates an embodiment of a method for a editing an existing listing;

FIG. 16 illustrates an exemplary member family shown as three tiers (levels);

FIG. 17 illustrates an embodiment of a method for determining compensation based on a business subscribing to the service provider;

FIG. 18 illustrates an embodiment of a method for a service provider to supply to a member updated local listing Web site;

FIG. 19 shows an embodiment of a computing system.

### DETAILED DESCRIPTION

As described earlier, local businesses are typically not satisfied with their Internet business presence. This may be because of a lack of resources, expertise, time, etc. Below we describe a new approach to providing large and small, local or multiple location businesses with an easily obtainable presence on the Internet through a local listing service provider (“service provider”). The service provider compiles business information with the help of its members and creates an Internet presence for these businesses.

Business information is collected not only from the businesses themselves but by individual consumers (members of the service provider) under an approach designed to financially benefit everyone involved (members (business and consumer), businesses, and consumers). This information is conveyed to a user as a listing, which is a short description of the local business including its products, services, location, etc. If the listing describes a professional, e.g., a lawyer, other relevant information such as a bibliographic history may be provided, which may include education, areas of expertise, years in practice, licenses, etc. Other listing types may also be utilized including “help wanted” listings, personal ads, etc. These listings are again created and maintained by members of the service provider. Through this approach, the service provider will develop a comprehensive collection of current information on businesses and professionals, including their products, services, and sales and/or specials. These listings are searchable via a search engine either supplied by the service provider or a third party search engine such as Google™ or Yahoo!™. In addition to a listing, in one embodiment the service provider supplies a link to a page that allows a business to include more information and photograph(s).

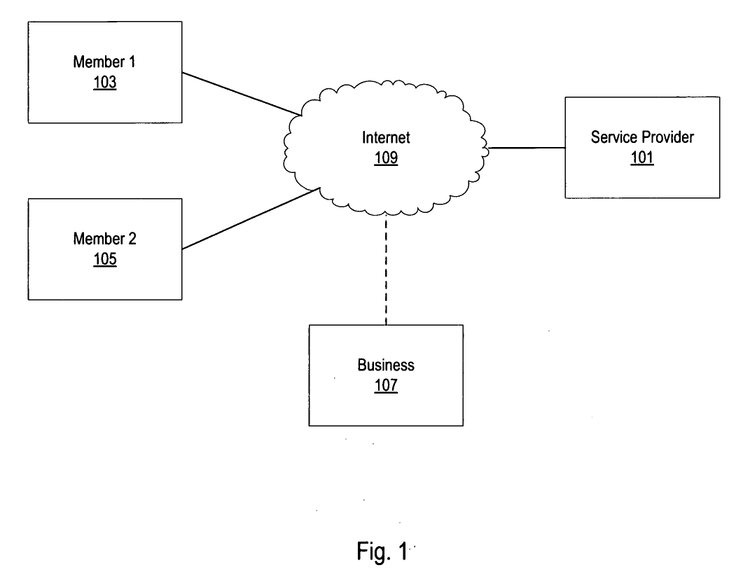

FIG. 1 illustrates an embodiment of the overall system for providing member created business listings. The service provider 101 receives listings from business such as business 107 through the Internet 109. These listings are developed by members of the service provider such as Member 1 103 and Member 2 105. The members use various tools provided by the service provider 101 to develop listings for businesses and/or professionals for the service provider 101 to host online. Businesses, such as business 107 may also be members of the service provider 101 and may create and/or maintain their own listing. However, as illustrated by the dotted line, these businesses may not have an Internet presence and must rely on members to create their listing for them.

### Exemplary Embodiments of Functionality Provided by a Service Provider

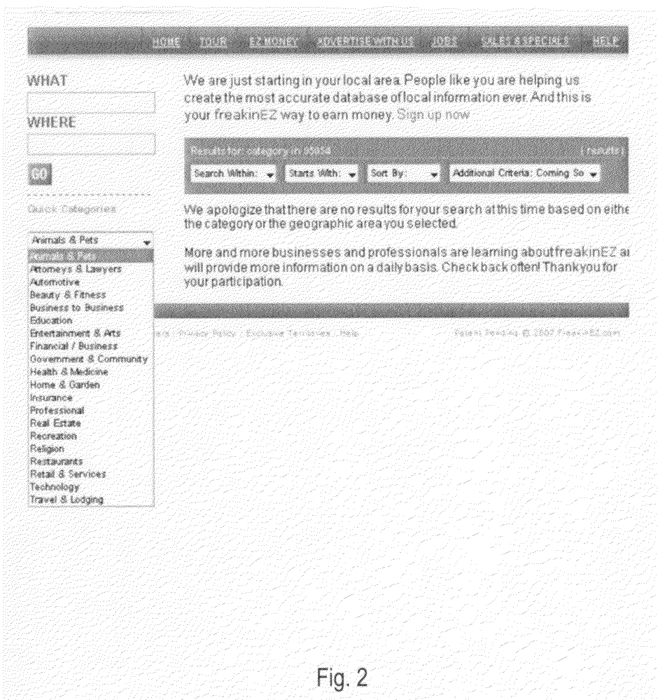

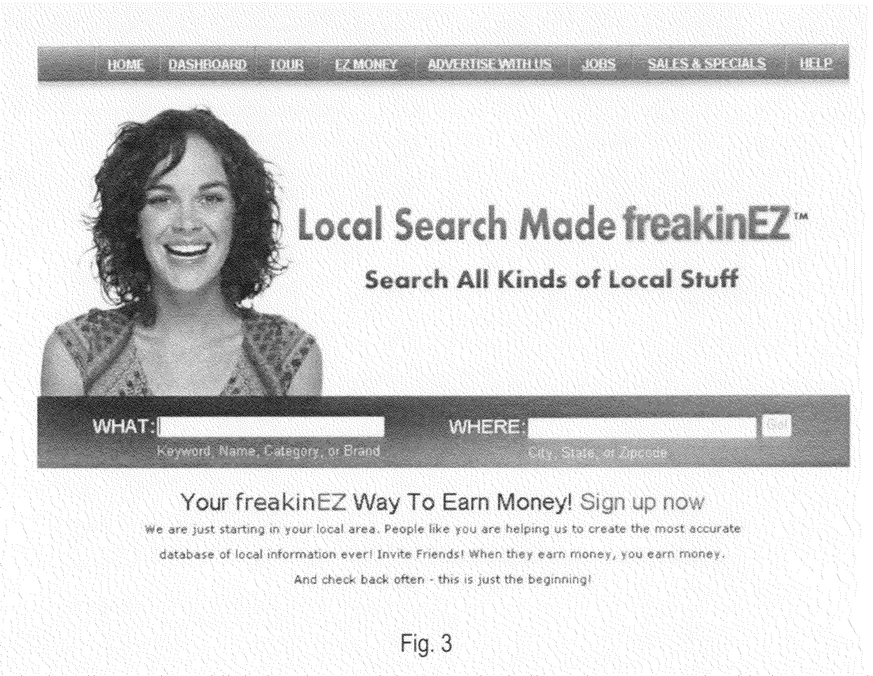

FIG. 2 illustrates an embodiment of a listing search page. Users of the search page may search the listings supplied by the service provider for the local business or service that they need. Searches may be categorical, location specific, and/or specific in nature. Exemplary categories include: animals and pets; attorneys; automotive; beauty; fitness; education; entertainment and arts; financial/business; government and community; health and medicine; home and garden; insurance; professional; real estate; recreation; religion; restaurants; retail and services; technology; and travel and lodging. Subcategories of the categories may also be used. Location specific searches may be performed by address, city/state, and/or zip code. Or, a user may simply search by business name, keyword, or brand name. FIG. 3 illustrates another embodiment of a listing search page.

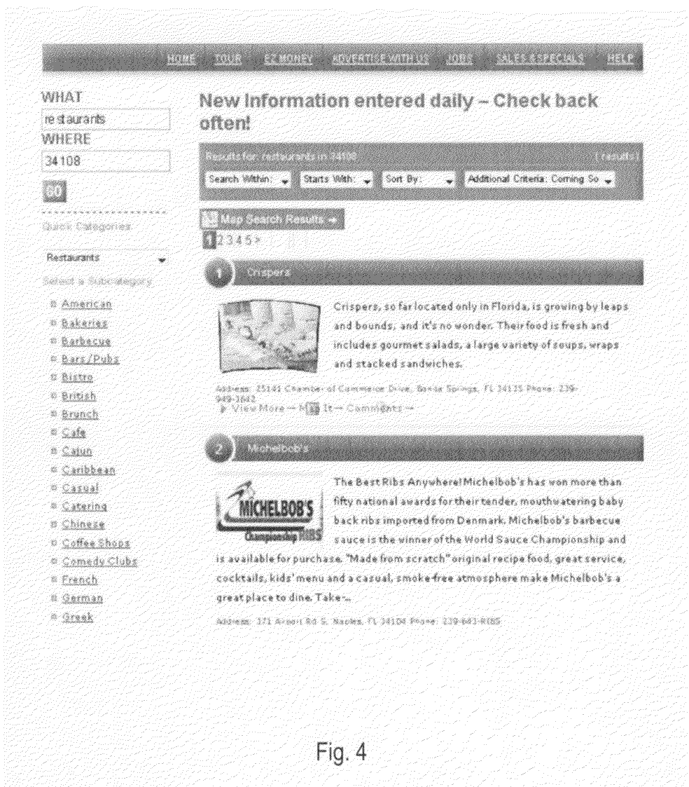

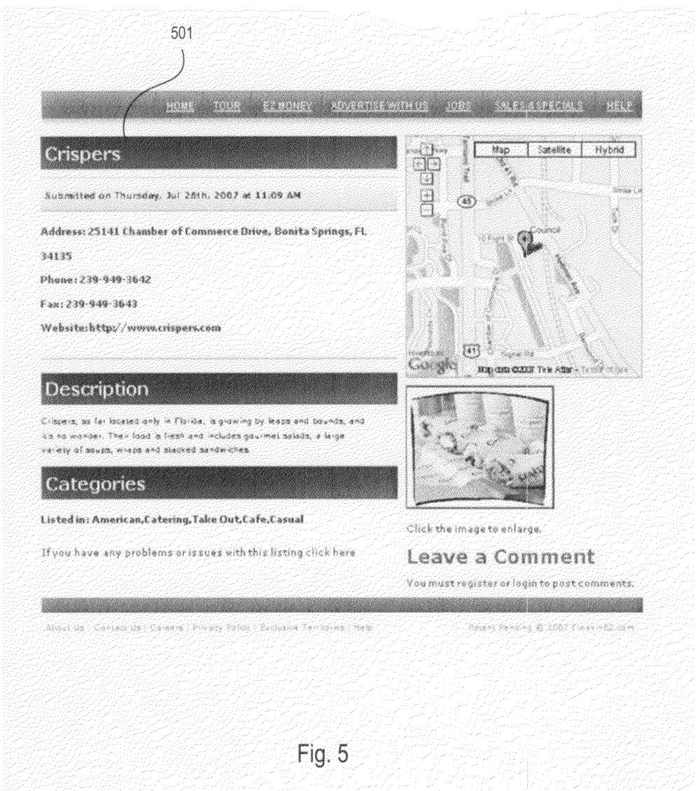

FIG. 4 illustrates an exemplary result of a listing search. These search results represent results for a search of restaurants in the 34708 zip code. Any person accessing the service provider's site may perform this search (including members and non-members). As illustrated, the search returned several listings. A user may select a listing for more information (see FIG. 5). Additionally, the search result may be further tailored by subcategory, name, keyword, brand name, mileage from location, etc. Finally, the search result may also provide a map of all of the locations of the businesses returned by the search.

FIG. 5 illustrates an exemplary business listing. This listing 501 is for Crispers (a restaurant in Bonita Springs, Fla.). As illustrated, the listing includes the contact information for Crispers including its address, phone and fax numbers, and website address. A short description of Crispers is included in the listing. As illustrated, this particular business is listed in several categories. The service provider typically includes a section for registered members to leave comments about the business. A listing may also include a map of the location of the business and a link that provides directions to the business. Any part of this listing may be edited by the business if it is a member of the service provider.

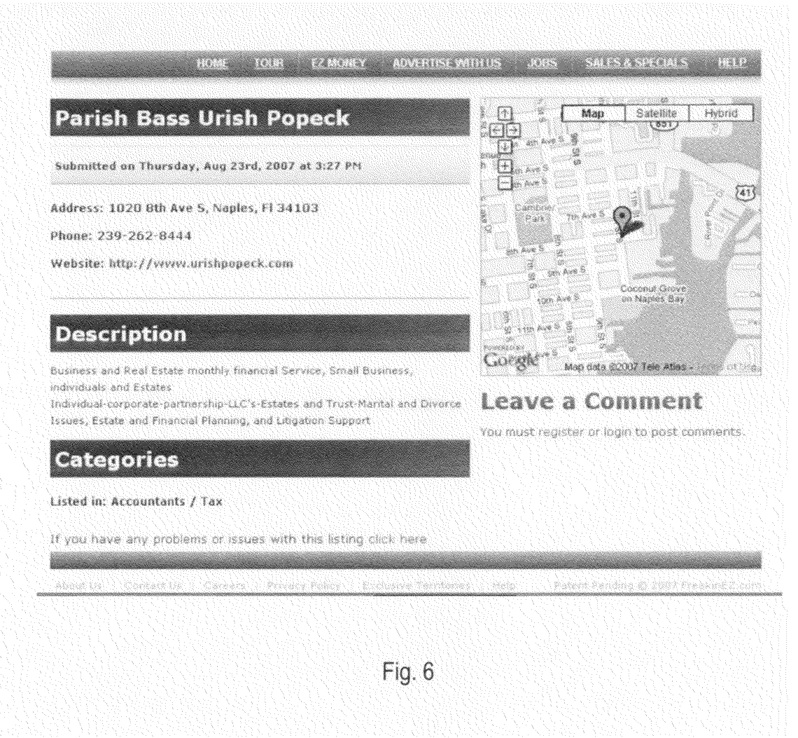

FIG. 6 illustrates an exemplary professional listing. As illustrated, the listing includes the contact information for the firm including its address, phone and fax numbers, and website address for an accounting firm. A short description of the firm is included in the listing. This particular business is listed in the “accounting” category and then “tax” subcategory. The service provider typically includes a section for registered members to leave comments about the business. A listing may also include a map of the professional's location and a link that provides directions to the business. Any part of this listing may be edited by the professional if it is a member of the service provider.

### Becoming a Member of the Service Provider

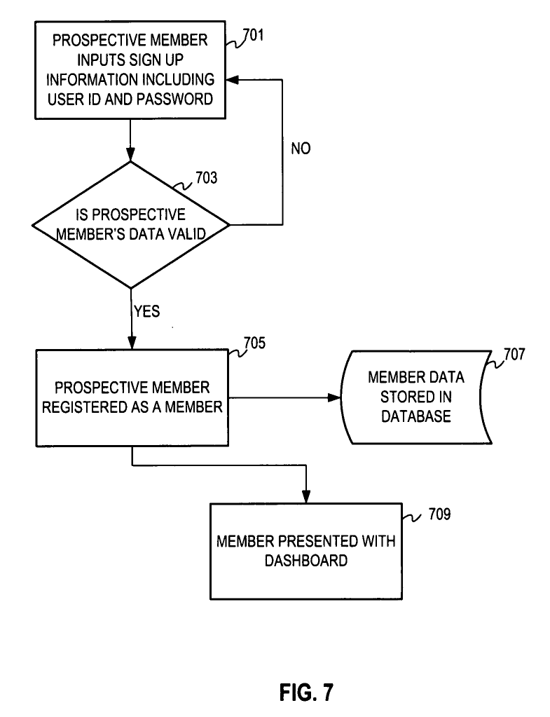

FIG. 7 illustrates an embodiment of a method for registering a member with the service provider. The prospective member inputs “member details” at 701. These member details include a member identification (“ID”) and a password. Member details typically also include one or more of the following: the member's name, email address, zip code, birth date, and an indication of the person that referred the prospective member (if applicable). Additionally, a member's details should include information as to how the member desires to be paid. Details will include the physical address of the member and a social security number or tax ID. Forms of payment include, but are not limited to, payment to a PayPal™ or Google™ Checkout account, payment to a bank account, payment to a debit card, a check or money order sent to a physical location, etc. However, this payment information may be inputted at a later time.

The prospective member's member details are validated at 703. Validation includes determining if the member name is available, the password is acceptable, etc. If the details are not valid, the prospective user will be prompted to change his/her details.

Once the prospective member's details have been validated the prospective member becomes a registered member at 705. The member's details are persisted to a database at 707. The member is then presented with his member dashboard at 709.

### Exemplary Member Dashboard

FIG. 6 illustrates an embodiment of a member dashboard. As illustrated, the member dashboard 801 is a webpage that includes links to various member functions including one or more of the following functions: adding a listing, viewing existing listings, inviting a friend to join the service provider, viewing activities of friends, calculating potential earnings for the member, viewing the amount of money earned by the member, editing member information (e.g., user name, password, email address, and financial information), etc. The dashboard 801 may also include links to other portions of the service provider's website such as a tour of the site, an advertising section, an employment section, a sales and specials section, a help section, etc. This particular member has not created a listing and has not referred any friends.

While the dashboard 801 is illustrated as a website it should be understood that the dashboard 801 may take on other forms such as a standalone client. Additionally, the functionality provided by the dashboard 801 may be spread across one or more pages.

### Referring a Friend to the Service Provider

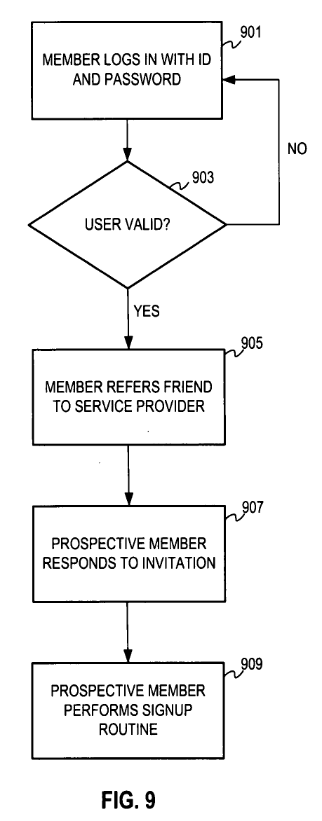

FIG. 9 illustrates an embodiment of a method for referring (inviting) a friend to the service provider. As detailed above, there are many benefits to referring friends or acquaintances to join the service through a member. These referral members not only help the number of listings grow, but also potentially provide additional revenue to the person that referred them to the service provider.

An existing member attempts to log into his account using his/her username and password at 901. A determination of the validity of the provided credentials is made at 903. If the username and password are not valid, then the member will be prompted to resubmit his/her username and password. If the credentials are valid, then the member is typically taken to his/her personalized dashboard such as the dashboard illustrated in FIG. 6.

From the dashboard (or standalone equivalent), the member takes the necessary steps to refer a friend or acquaintance to the service at 905. In one embodiment, the routine involves crafting and sending an email or other electronic message to the prospective member. The message includes a reference to the referring member, e.g., through a link. Of course, a member may also simply tell a friend or acquaintance about the service provider and have that friend or acquaintance give credit to the member upon registering.

At some later point in time, the prospective member responds to the invitation at 907 and performs a signup routine (such as the one described in reference to FIG. 1) to join the service at 909.

### Developing a Listing

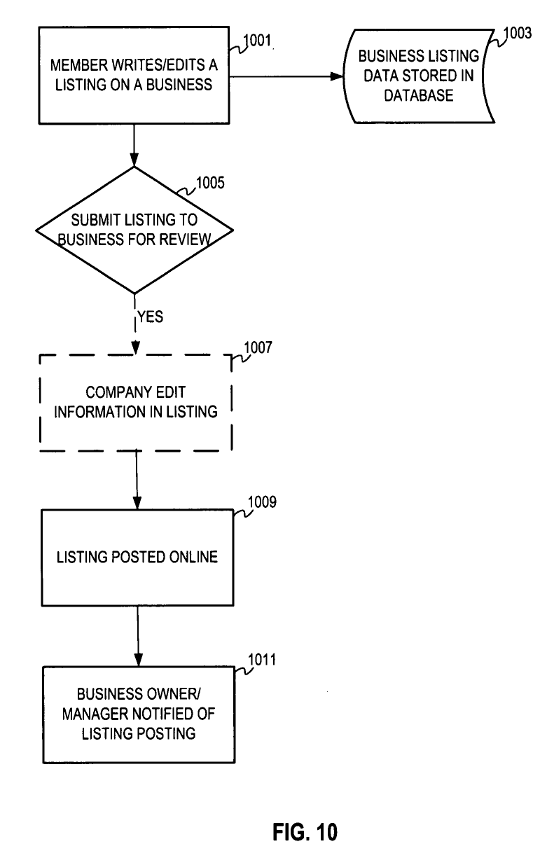

FIG. 10 illustrates an embodiment of a method for developing a listing by a member. As described earlier, a listing may be generated by a member and proposed to a business for inclusion by the service provider. Of course, a business is free to develop its own hosted listing. At 1001, a member writes or edits a listing describing a business. There are numerous ways for a member to obtain information about a business, i.e., a member may write about a business he/she is employed with or frequents. Information on businesses from printed ads in local newspapers, local magazines, phone directories, and other specialized publications may also provide information for a listing. Significant information may also be found on individual websites, other search engines, or websites that focus on specific industries and/or business categories, i.e., restaurants, shopping, hotels, etc.

When generating a listing for a professional, there are also several different sources of information. A member may choose to write about professionals that he/she knows. A member may contact a professional and ask for their information. Printed ads in local newspapers, local magazines, phone directories, and other specialized publications also may provide information for a listing. Some professionals also maintain individual websites containing this information. Additionally, other search engines or websites that focus on specific categories, i.e., doctors, dentists, hospitals, insurance companies, realtors, legal associations, etc. may supply information needed to create a listing for a professional.

In addition to the description, a member should try to provide the following contact information: address of the business, telephone and fax numbers of the business, e-mail address of the business, or the name and title of a contact person at the business. A contact person is usually the owner, manager or advertising manager who has the authority to make business decisions and/or advertising decisions on behalf of the business.

A member-created listing is persisted to a database of the service provider at 1003. The service provider may utilize several different databases for redundancy and/or efficiency purposes

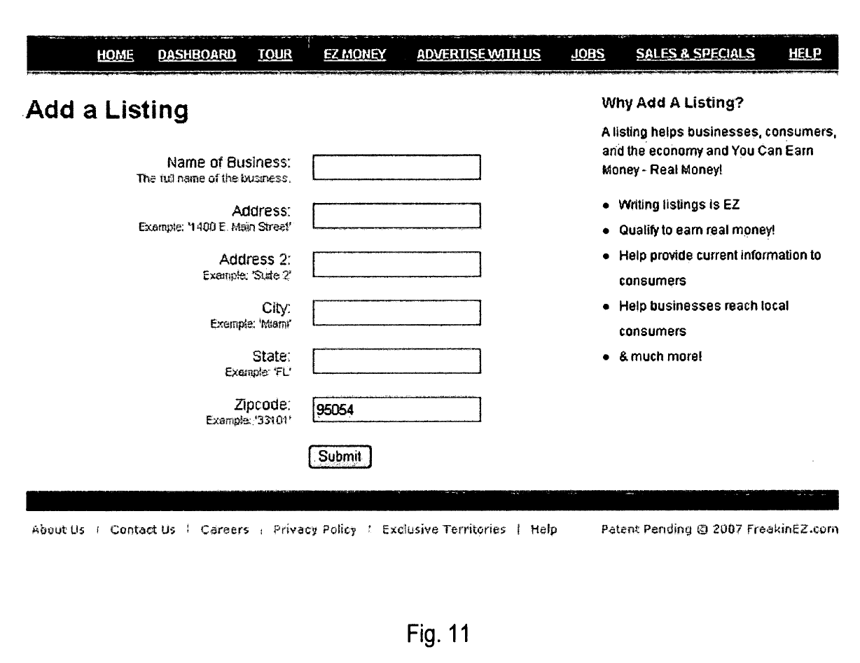

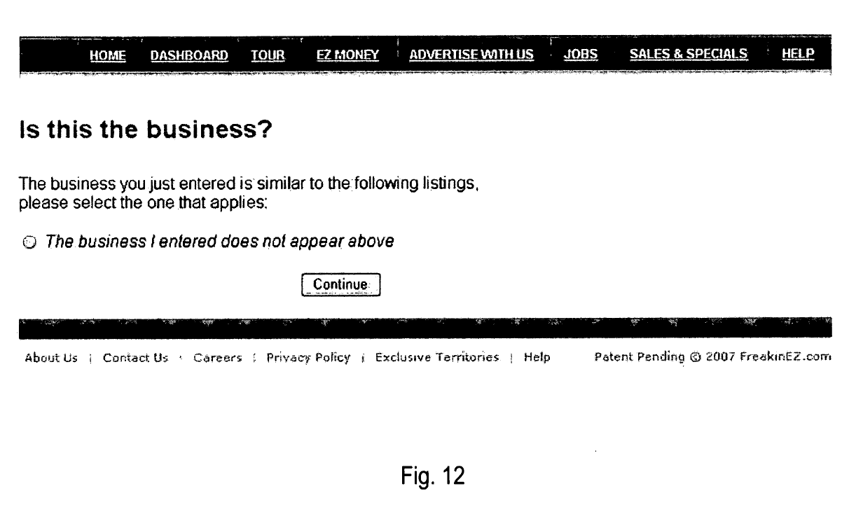

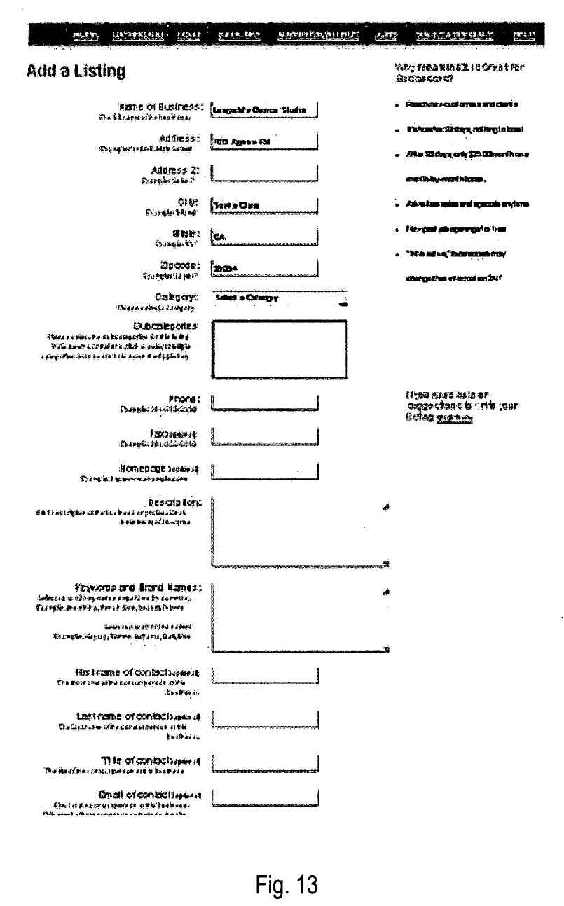

FIG. 11 illustrates an exemplary first “add listing” page that is accessible from a dashboard. As illustrated, a member first supplies the name and address of a business. FIG. 12 illustrates an exemplary “Is This The Business?” page on which the member selects an existing business listing or if the business does not have a listing the member continues to a second “add listing page.” FIG. 13 illustrates an exemplary second “add listing” page. In this page the member supplies additional information (and the name and address if not provided earlier) including, but not limited to, the category or categories of the business (including sub-categories), a phone and fax numbers (if available), a URL to the business' homepage (if available), a description of the business, some keywords associated with the business to be used for searching, brand names, contact name (if available), and/or a picture (if available). Of course, a single “add listing” page or client may be used or the “add listing” function may be further divided into more pages. Similar pages are available for developing job openings or professional listings.

At some point later in time the member or the service provider will present the listing to the business for review at 1005. This presentation may be made in person, via fax, via a link to the listing as is (online for the business to view), etc. The business may be free to decline the listing if it is not satisfactory. The business may also edit (or have the member edit) the information contained in the member created listing at 1007. Of course, the listing is editable both prior to and after inclusion with the other listings.

After approval of the listing by the service provider and/or business and payment to the service provider, a listing is included with the other listings at 1009. At this point, the business now has a searchable presence that is freely accessible. The business is notified of this inclusion at 1011. In another embodiment, the listing is hosted by the service provider regardless of input from the local business.

### Method for a Business to Join a Service Provider

Typically, prior to the listing going online, the business should also become a member. However, the listing may be put online prior to the business becoming a member so that the business can review the listing online. If the business does not want to become a member it cannot revise its listing (other than to change original information included in the listing). However, it may request that the listing be removed. Additionally, according to an embodiment, businesses that are paying members (they are paying to maintain their listing with the service provider) will have their listing ahead of non-paid listings when a search has been conducted.

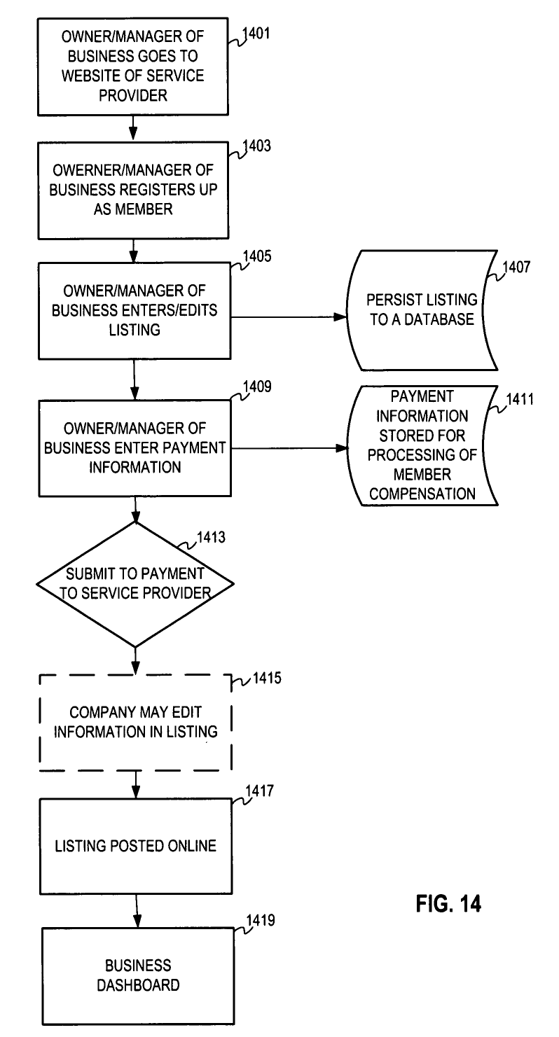

FIG. 14 illustrates an embodiment of a method for a business to sign-up with the service provider. A business visits the service provider to determine if it should join at 1441. For example, the business' owner or manager visits the website of the service provider much like a prospective member does. Once at the website, the business can see what other businesses are listed, what services the service provider offers to businesses and consumers, etc.

If the business is interested in becoming member and/or placing a listing, the business signs up as a member at 1403. The sign up procedure for businesses is similar, if not identical, to the procedure for an individual to sign-up with the service provider. During sign-up it is important for the business to give credit to the member that provided the referral and/or listing to the business. If the business does not provide credit, it is difficult to ascertain if the member should get paid. However, the business may provide this information at a later time or the member's profile could be checked for created listings to see if the member created one similar to the one accepted by the business.

If a listing already exists, the business may edit the listing or have the listing edited on its behalf at 1405. Alternatively, if there is not a pre-existing listing for the business, the business may create one at 1405. The business' listing is persisted to a database at 1407.

If it has not already done so, the business may supply its payment information, e.g., credit card, PayPal™, Google™ checkout, bank account information, etc. to the service provider at 1409. This payment information is stored for processing of member compensation at 1411 and payment is submitted to the service provider at 1413.

At any point in time the business may edit its listing including after submission of payment to the service provider at 1415. After payment has been received, the listing is posted online at 1417 and is searchable through the service provider's interface or other search engine (indexing search engines such as Google™ are likely to index the service provider's website as well thereby making the listings available using their index(es)). Finally, in an embodiment, after the listing is posted the business is routed back to its dashboard at 1419.

### Editing a Listing

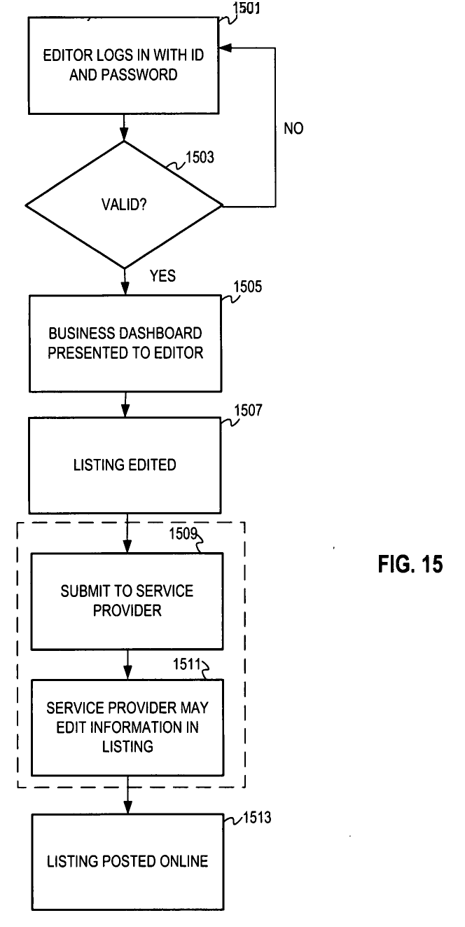

One of the unique aspects allowed with the above-described listing approach is that a listing may change over time. The listing may be supplemented with specials, updated goods or services provided by the business, updated contact information, etc. with relative ease. Additionally, persons with little to no computer experience are able to edit and post listings. FIG. 15 illustrates an embodiment of a method for a editing an existing listing.

In order to edit a listing, the editor of the listing needs to log in to the service provider at 1501. At 1503, a validation of the log in credentials is performed. Once logged in, the editor is presented with their dashboard at 1505. If the editor is a business, then this dashboard allows the business to edit its listing(s). A business may also create listings for others in which case the dashboard will also present those listings if available. In an embodiment, once a listing is accepted by a business, it can only be edited by the business unless the business has indicated otherwise. If the editor is a normal member, his/her personal dashboard allows him/her to edit listings that they have created. This may be necessary to update a listing that was rejected by a business. In an embodiment, business members may also run employment ads with the service provider in an employment section. Anytime the business wants to offer services or goods beyond the regular scope of their business (such as a sale or special) it may do so through its dashboard. In an embodiment, consumers may view all sales and specials by clicking on a link provided by the service provider.

The listing is edited at 1507. Almost any aspect of the listing may be edited including, but not limited to, the name, contact information, description, etc. of the business. In an embodiment, the business may also edit comments posted about it in the listing, however, this is atypical.

The edited listing is submitted to the service provider at 1509. In an embodiment, the listing may undergo a review process at 1511. The review process allows the service provider to ensure that the content of the listing is in compliance with whatever guidelines it has in place. Accordingly, there may be some delay between when changes are made and when they are reflected on the website. An acceptable listing is then republished online at 1513.

### Tiered Member Levels

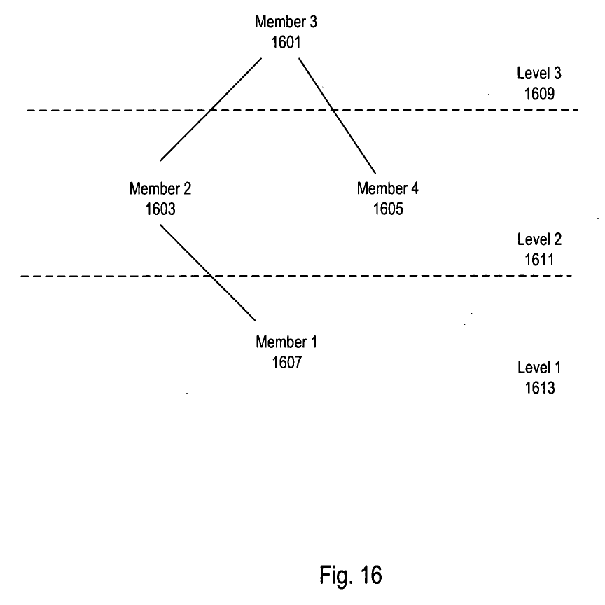

A member's compensation depends on several factors including: the businesses that he/she brings in (and sign up and pay for the service provider for the ability to maintain a listing) and the businesses that his/her “friends/referrals” bring in that also sign up and pay the service provider. FIG. 16 illustrates an exemplary member family shown as three tiers (levels). This configuration graphically depicts the relationship between members of the service provider. “Member 3” 1601 is designated as being in the lowest level or Level 3 1609 with respect to the member (“Member 1” 1607) that brought in a business. Being in this level means that “Member 3” signed up with the service provider without being prompted (or at least did not give credit to the person that prompted him) by another member.

“Member 3” 1601 referred two members to the service provider, “Member 2” 1603 and “Member 4” 1605. The latter two members are in different level (Level 2 1611) than “Member 3” 1601. These two members are closer to the member that brought in the business to the service provider. Of these two, only “Member 2” 1603 is related to “Member 1” 1607 (the member that brought in the business. “Member 1” 1607 is in the top level or Level 1 1609.

As illustrated, “Member 3” 1601 has the potential to financially benefit the most if each member signs up the same amount of businesses as “Member 3.” This will allow for “Member 3” to receive a percentage of the fees brought in by “Member 2” 1603, “Member 4” 1611, and “Member 1” 1607. Since “Member 1” 1607 has not brought in any other members, he only gets a portion of the fees that he directly brings into the service provider.

To promote growth of the service provider, each business is charged the same fee. However, in one embodiment, the fee charged to a business is dependent on the local market as determined by the service provider. For example, businesses in New York City would pay more than businesses in Des Moines, Iowa. In this market specific scenario, members from higher paying markets could end up making more for the same amount of work.

### Member Compensation

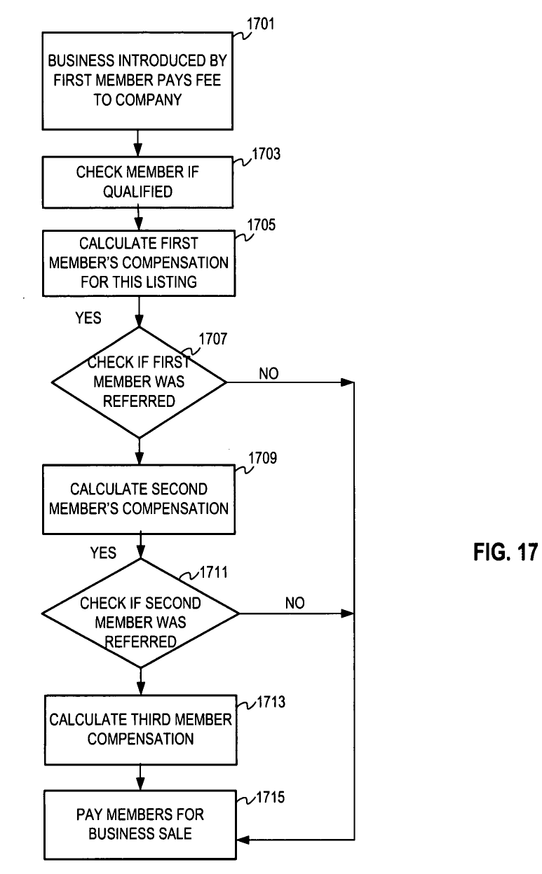

FIG. 17 illustrates an embodiment of a method for determining compensation based on a business subscribing to the service provider. A business introduced by a first member pays a fee to the service provider at 1701. The business has accepted the business listing developed by the first member and has agreed to have the service provider host the listing. For example, “Member 1” introduced “Butters' BBQ” to the service provider and developed a listing for “Butters' BBQ.” When “Butters' BBQ” accepted that listing, it paid a fee to the service provider.

A check to determine if the first member is qualified is performed at 1703. According to an embodiment, a member must have a minimum of two “active clients” in a pay period to qualify for payment from the service provider. An “active client” is a business (or professional), on which the member wrote a listing, and that joined service provider as an active client. According to another embodiment, non minimum active clients are required for the member to get paid.

The compensation to be paid to the first member is calculated at 1705. The compensation is a portion (percentage) of the fee paid by the introduced business to the service provider. Any percentage may be used for this calculation. Of course, adjustments to the compensation amount may be utilized. For example, if a member has brought in a large amount of businesses, the member would get a larger percentage of the associated fees. Or, a member may get a bonus for reaching certain milestones such as certain number of businesses signed up in a month, year, etc.

A check to determine if the first member was referred to the service provider by another member is performed at 1707. If the first member was not referred, then the first member is the only member that gets paid for the business signing up with the service provider at 1715.

If the first member was referred to the service provider by a second (another) member, then that second member will also get a portion of the business' fee paid to the service provider. At 1709, the portion due to the second member is calculated. For example, if “Member 1” was referred to the service provider by “Member 2” and “Member 1” convinced “Butters' BBQ” to have a listing hosted by the service provider, “Member 2” also gets a portion (percentage) of the fee paid by “Butters' BBQ” to the service provider.

There are numerous ways to divide the fee paid by a business between members. In one embodiment, the fee to be paid to a group of members is a set percentage that is apportioned (equally or unequally) between the members responsible for the business paying the fee. For example, the members may get a total of 25% of the fee paid by a business. This 25% may be apportioned in any number of ways. Typically, the member that directly introduced the business to the service provider gets the largest percentage of this allotment on a sliding scale. Of course, using this type of configuration may result in members not giving credit to those that introduced them to the service provider as their portion would be lessened.

In another embodiment, there is not a set total percentage apportionable to members that brought in a business (directly or indirectly), however, there are set values depending upon the level that the member is associated with. For example, “Member 1” 1607 of FIG. 16 is in the first level. This means that he brought in the business. Accordingly, “Member 1” 1607 typically would get the largest percentage of the fee paid by business that he brings in. Related members (“Member 2” 1603 and “Member 3” 1601) would get a lesser percentage than “Member 1” 1607. Additionally, in an embodiment, the percentage due to a member decreases as the level value increase. For example, Level 1 1609 receives more than Level 2 1611, and Level 2 1611 receives more than Level 3 1613. The payment to the members generally does not exceed the total paid by the business to the service provider. However, depending upon other revenue sources for the service provider such as banner ads, etc. or special circumstances (attempted growth of the service provider's business) the payment to members may exceed the total paid by the business to the service provider.

At 1711, a check is performed to determine if the second member was referred to the service provider. If the second member was not referred, then only the first and second member will get a portion of the business' payment at 1715.

If the second member was referred to the service provider by a third member, that third member will also get a portion of the business' fee paid to the service provider as calculated at 1713. As discussed above, there are numerous ways to determine how much the third member should be compensated. Additionally, any number levels of member referral may be used. In an embodiment, the number of levels of member referral is up to four levels beneath a member.

According to one embodiment, a member receives 50% of the initial amount paid by any business on which he/she wrote a listing. The member will continue to earn 90% of any amount paid by that business on a monthly basis. Friends from the second level (referred by the member) earn 90% for the member on the initial amount paid by the business, when paid, and 5% monthly thereafter. Friends from the third level (referred to the service provider by one of the member's friends) earn 90% for the member on the initial amount, when paid, and 5% monthly thereafter. Friends from the next level earn the member 5% on the initial amount when paid and 2.5% monthly thereafter. Friends of the next level after that earn the member 5% on the initial sale when paid and 2.5% monthly thereafter, etc. Of course, any other payment scheme may be utilized. When a member earns a commission, he/she will be notified by the service provider. At that time, if the member had not previously done so, he/she should provide the service provider with additional information including banking information so that the service provider can facilitate a payment (such as a direct deposit) to the member.

### Service Provider Overview Method

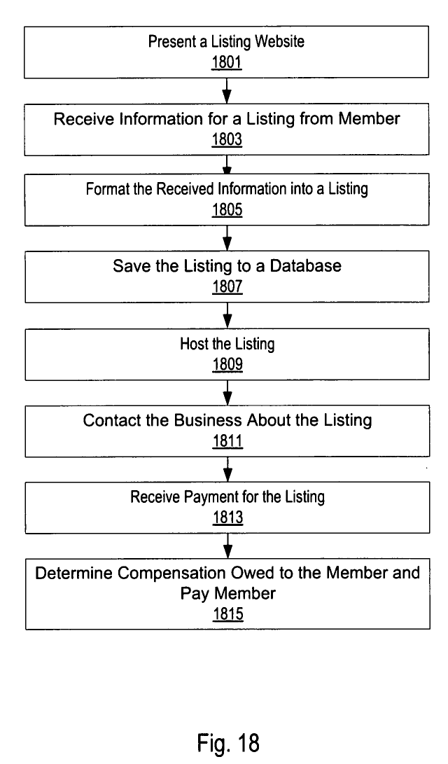

FIG. 18 illustrates an embodiment of a method for a service provider to supply to a member updated local listing Web site. The service provider presents a Web site at 1801. This Web site contains the pages described earlier including pages for: searching listings, listings themselves, member dashboards, etc.

At 1803, the service provider receives information about a listing from a member. The type of information received has been previously described. Additionally, this information is typically received via a page or pages that the service provider supplied to the member such as the pages illustrated in FIGS. 11, 12, and 13.

The service provider formats this information into a listing at 1805. Exemplary listings have been previously discussed. The listing is saved to a database at 1807.

Finished listings are hosted by the service provider at 1809 and made available to a user visiting the Web site of the service provider.

The service provider contacts the business about the listing at 1811. As described earlier, this allows the business to review the listing and possibly decide to join the service provider. If the business does join the service provider and pays to maintain the listing, then the service provider receives this payment at 1813.

Once payment has been received, the service provider determines the compensation owed to the member under the terms set forth by the service provider for compensation for listing creation and pays the member at 1815.

### Exclusive Territories

In an embodiment, the service provider utilizes “regional directors” in specific areas. These areas are designated around cities, towns and metropolitan areas, and generally based upon television and radio markets. Regional directors are individuals or businesses that contract (license) with the service provider to allow them to earn “overrides” on all sales generated in their territory. The cost of becoming such a regional director depends on the market of each exclusive territory.

In an embodiment, the service provider utilizes “regional directors” in specific areas. These areas are designated around cities, towns and metropolitan areas, and generally based upon television and radio markets. Regional directors are individuals or businesses that contract (license) with the service provider to allow them to earn “overrides” on all sales generated in their territory. The cost of becoming such a regional director depends on the market of each exclusive territory.

### Closing Comments

An article of manufacture may be used to store program code providing at least some of the functionality of the service provider described above. An article of manufacture that stores program code may be embodied as, but is not limited to, one or more memories (e.g., one or more flash memories, random access memories (static, dynamic or other)), optical disks, CD-ROMs, DVD-ROMs, EPROMs, EEPROMs, magnetic or optical cards or other type of machine-readable media suitable for storing electronic instructions.

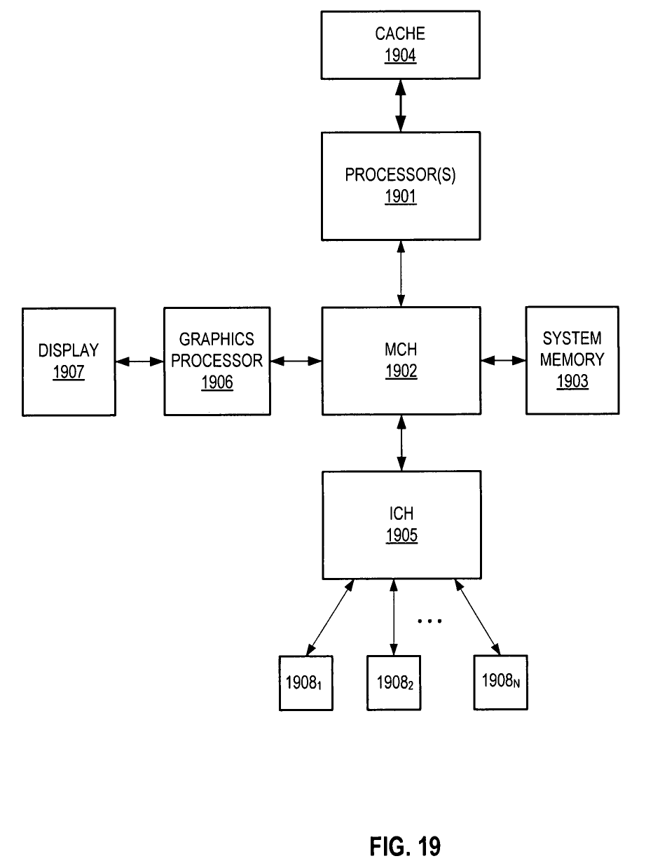

FIG. 19 shows an embodiment of a computing system (e.g., a computer) such as what would constitute a service provider. The exemplary computing system of FIG. 19 includes: 1) one or more processors 1901; 2) a memory control hub (MCH) 1902; 3) a system memory 1903 (of which different types exist such as DDR RAM, EDO RAM, etc,); 4) a cache 1904; 5) an I/O control hub (ICH) 1905; 6) a graphics processor 1906; 7) a display/screen 1907 (of which different types exist such as Cathode Ray Tube (CRT), Thin Film Transistor (TFT), Liquid Crystal Display (LCD), Digital Light Processing (DLP), Organic LED (OLED), etc.; and 8) one or more I/O and storage devices 1908.

The one or more processors 1901 execute instructions in order to perform whatever software routines the computing system implements. The instructions frequently involve some sort of operation performed upon data. Both data and instructions are stored in system memory 1903 and cache 1904. Cache 1904 is typically designed to have shorter latency times than system memory 1903. For example, cache 1904 might be integrated onto the same silicon chip(s) as the processor(s) and/or constructed with faster SRAM cells whilst system memory 1903 might be constructed with slower DRAM cells. By tending to store more frequently used instructions and data in the cache 1904 as opposed to the system memory 1903, the overall performance efficiency of the computing system improves.

System memory 1903 is deliberately made available to other components within the computing system. For example, the data received from various interfaces to the computing system (e.g., keyboard and mouse, printer port, LAN port, modem port, etc.) or retrieved from an internal storage element of the computing system (e.g., hard disk drive) are often temporarily queued into system memory 1903 prior to their being operated upon by the one or more processor(s) 1901 in the implementation of a software program. Similarly, data that a software program determines should be sent from the computing system to an outside entity through one of the computing system interfaces, or stored into an internal storage element, is often temporarily queued in system memory 1903 prior to its being transmitted or stored. The system memory 1903 may includes one or more modules to provide the functionality described above including, but not limited to, modules for: generating a Web site including a search page, member dashboards (and the functionality described with respect to the dashboard including referring friends, generating/editing listings, viewing compensation earned, etc.), listings, etc.; determining compensation for the members of the service provider; handling payments to or from the service provider and members; storing listings; etc. These modules may also be stored on articles of manufacture and executed at runtime by the computing system.

The ICH 1905 is responsible for ensuring that such data is properly passed between the system memory 1903 and its appropriate corresponding computing system interface (and internal storage device if the computing system is so designed). The MCH 1902 is responsible for managing the various contending requests for system memory 1903 access amongst the processor(s) 1901, interfaces and internal storage elements that may proximately arise in time with respect to one another.

One or more I/O devices 1908 are also implemented in a typical computing system. I/O devices generally are responsible for transferring data to and/or from the computing system (e.g., a networking adapter); or, for large scale non-volatile storage within the computing system (e.g., hard disk drive). ICH 1905 has bidirectional point-to-point links between itself and the observed I/O devices 1908.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense. For example, the service provider may not host listings using its computers but rather contract the hosting to a third-party hosting provider. Additionally, while the description above details an Internet based search engine, the listings may be distributed on physical media such as a CD-ROM or DVD-ROM.

The above described approach to business advertising provides a benefit to members of the service provider (consumers and businesses) and non-members of the service provider who can simply search for the information that they need. Consumers, looking for a local product or service, benefit because they have immediate access to current and comparative information. Businesses and professionals benefit because the service provider supplies an easy and inexpensive way to provide the general public with current information on their products, services, and sales and/or specials. Consumers who are also members have the opportunity to benefit financially as they participate in providing information to the service provider's expanding database of listings.

1. An article of manufacture including program code which, when executed by a processor, causes the processor to perform a method, the method comprising:
calculating a first member's compensation for generating a listing about a business for inclusion on a service provider's website, wherein the calculation is made after the business has paid the service provider for the listing;
compensating the first member for the listing.

2. The method of the article of manufacture of claim 1, further comprising: determining if the member meets a preset qualification for compensation.

3. The method of the article of manufacture of claim 2, wherein the preset qualification is that the member have two paying business referrals for listings that the member authored.

4. The method of the article of manufacture of claim 2, further comprising:
determining if the first member was referred by a second member to the service provider;
if the first member was referred to the service provider by a second member,
calculating the compensation for the second member for the first member's generation of the paid listing about a business for inclusion on a service provider's website; and
compensating the second member for the listing.

5. The method of the article of manufacture of claim 4, wherein the compensation paid to the second member is less than the compensation paid to the first member.

6. The method of the article of manufacture of claim 1, wherein the compensation is in the form of an electronic payment to the first member.

7. A method comprising:
receiving information from a member for a listing describing a business;
formatting the information into a listing to be displayed by a service provider;
persisting the listing to a database;
hosting the listing on a website provided by the service provider, wherein the listing is searchable by any user visiting the website;
receiving payment from the business or professional for hosting the listing;
determining compensation for the member that created the listing; and
compensating the member that created the listing.

8. The method of claim 7, wherein the information received from the member includes one or more of the following:
an address of the business;
a name for the business;
a description of the business;
contact information for the business; and
keywords to be used in searches for the business.

9. The method of claim 7, further comprising:
contacting the business about the listing.

10. The method of claim 7, further comprising:
providing a search engine to a user for the user to search listings hosted by the service provider.

11. The method of claim 7, further comprising:
determining if the first member was referred by a second member to the service provider;
if the first member was referred to the service provider by a second member,
calculating the compensation for the second member for the first member's generation of the paid listing about a business for inclusion on a service provider's website; and
compensating the second member for the listing.

12. The method of claim 8, wherein the listing includes information about the business comprising:
an address of the business;
a name for the business;
a description of the business;
contact information for the business.

13. The method of claim 12, wherein the listing further comprises member created comments about the business.

14. An article of manufacture including program code which, when executed by a processor, causes the processor to perform a method, the method comprising:
receiving information from a member for a listing describing a business;
formatting the information into a listing to be displayed by a service provider;
persisting the listing to a database;
hosting the listing on a website provided by the service provider, wherein the listing is searchable by any user visiting the website;
receiving payment from the business or professional for hosting the listing;
determining compensation for the member that created the listing; and
compensating the member that created the listing.

15. A data processing system, comprising:
a processor; and
a memory coupled to the processor for storing instructions, which when executed from the memory cause the processor to:
provide a Web page to a member to provide information on a business;
receive information from the member for a listing describing the business;
format the information into a listing to be displayed by a service provider;
persist the listing to a database;
host the listing on a website provided by the service provider, wherein the listing is searchable by any user visiting the website;
receive payment from the business or professional for hosting the listing;
determine compensation for the member that created the listing; and
compensate the member that created the listing.

16. The data processing system of claim 15, further comprising an instruction which when executed causes the processor to:
provide a Web page detailing a member's account with the service provider, wherein the Web page includes information on:
referrals that the member has brought to the service provider, money earned by the member from listings the member and the member's referrals have created,
listing created by the member, and
links to other Web pages for referring new members and creating new listings.
